(19) United States
(12) Patent Application Publication
(10) Pub. No.: US 2009/0008488 A1
(43) Pub. Date: Jan. 8, 2009

(54) COMMINUTION ROTOR FOR PRODUCING WOOD CHIPS

(75) Inventor: Artur Willibald, Uberlingen (DE)

Correspondence Address: BACHMAN & LAPOINTE, P.C., 900 CHAPEL STREET, SUITE 1201, NEW HAVEN, CT, 06510, US

(73) Assignee: AHWI MASCHINENBAU GMBH, Herdwangen (DE)

(21) Appl. No.: 12/282,709

(22) PCT Filed: Feb. 20, 2007
(86) PCT No.: PCT/EP2007/001448

§ 371 Date: Sep. 12, 2008

(30) Foreign Application Priority Data
Mar. 14, 2006 (DE) 10 2006 012 117.1

(51) Int. Cl. B02C 13/26; B27L 11/00

(52) U.S. Cl. 241/191; 241/294; 144/374

(57) ABSTRACT

In a comminution rotor for producing wood chips comprising a rotor shaft which has an associated rotor element, the rotor element has associated therewith individual web elements which at least partially revolve and are axially spaced apart from one another and into which blades are inserted.

### BACKGROUND OF THE INVENTION

The present invention relates to a comminuting rotor for producing wood chips, comprising a rotor shaft which is assigned a rotor element.

Conventional comminuting rotors for producing wood chips are known and available on the market in a wide variety of forms and designs. They are frequently inserted into corresponding comminuting equipment, devices and systems for producing wood chips. These are subject to a high level of stress and a high degree of wear, in particular in the case of hard materials which are to be comminuted, such as hard woods or ready-dried organic materials.

The conventional comminuting rotors are driven by means of powerful drives and have a large number of blades which work together with counterblades.

Only limited production quantities can be achieved in this case since it is necessary when producing wood chips for a wood chip length or chip length to be set exactly in order to be able to produce the wood chips with a desired quality.

Excessive wear of the conventional comminuting rotors means that it is not conventionally possible to provide a long-term guarantee of high wood chip quality. It is too often the case that the comminuting rotors or their blades have to be exchanged, a situation which is very expensive and undesirable.

The object of the present invention is to provide a comminuting rotor for producing wood chips that overcomes the stated disadvantages and by means of which larger production volumes of wood chips can be produced in higher and more uniform qualities, in particular as far as the chip length and chip thickness are concerned.

Furthermore, it is intended to significantly increase the service life of a comminuting rotor, to make it easier to exchange blades, and to make it possible to set and influence the wood chip length.

### SUMMARY OF THE INVENTION

This object is achieved by the features of the present invention wherein individual web elements are mounted on a rotor element which can be rotatably driven, preferably encircling the latter, with annular grooves being formed in each case between the individual web elements. The web elements themselves serve for actually receiving the blade, which is inserted therein via corresponding baseplates, endplates and inserts.

In order to preserve the actual blade, a wear protection element is provided below the blade.

To facilitate chip removal, a corresponding recess is formed in the web element itself in front of the actual blade and in front of the wear protection element.

In the recess in the actual web element is inserted a chip divider which is formed therein from the recess itself or can be inserted fixedly or releasably therein, said chip divider serving to remove and, if appropriate, subdivide the chip itself into the respective adjacent annular grooves of the web element.

Chip removal and chip division is significantly promoted in this way, with the result that high production rates, high rotational speeds and very large production volumes can be managed.

Furthermore, it has proved to be advantageous in the present invention for a wear element to be inserted into the outer circumferential surface of the web element in front of the recess and in front of the actual blade, this wear element, if appropriate, reducing the outer radius or diameter of the web element in order also to define a gap height between wear element and blade. This gap height can be varied through a corresponding different choice of thickness of the wear element or a corresponding geometry or different length of the wear element.

As a result, it is possible to influence the length of the wood chips through the corresponding choice and setting of the gap height.

Furthermore, such a wear element can be produced from very hard and wear-resistant material, thus resulting in a significantly increased service life as well. This is also intended to come within the scope of the present invention.

### BRIEF DESCRIPTION OF THE DRAWINGS

Further advantages, features and details of the invention will become apparent from the description given below of a preferred exemplary embodiment, in which:

FIG. 1 shows a schematically represented plan view of a comminuting rotor for producing wood chips;

FIG. 2 shows a schematically represented plan view of the rotor element according to FIG. 1;

FIG. 3 shows a schematically represented longitudinal section according to FIG. 2, through the rotor element along line III-III;

FIG. 4 shows a schematically represented side view of the comminuting rotor according to FIG. 1;

FIG. 5 shows a schematically represented enlarged view of a region of a web element for receiving the blades.

### DETAILED DESCRIPTION

According to FIG. 1, a comminuting rotor R according to the invention has a rotor shaft 1 which imparts a rotor movement to the comminuting rotor R itself via an electric, hydraulic or electromechanical drive, which is not represented here in further detail. The rotor shaft 1 can be formed as a sleeve itself or via an additional shaft having, if appropriate, an interposed coupling or the like. The invention is not limited thereto.

The comminuting rotor R is a constituent part of a machine or of device for comminuting organic materials, in particular trees, shrubs etc., for producing wood chips.

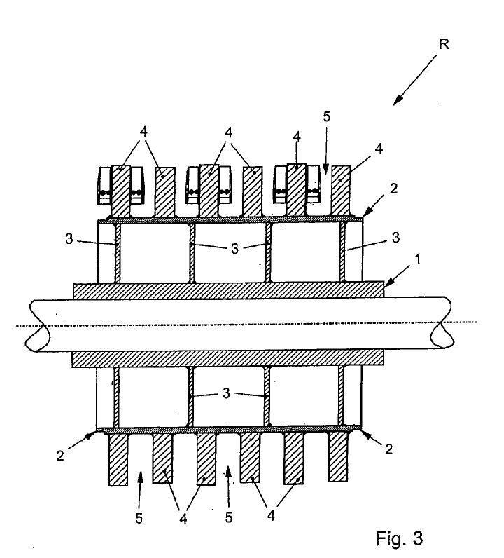

In this case, the comminuting rotor R has a rotor element 2 which, in the preferred exemplary embodiment, is of cylindrical design. In the preferred exemplary embodiment, the rotor element 2 is spaced via a multiplicity of annular disks 3 as is also indicated in FIG. 3, wherein the rotor element 2 itself is fixedly connected, in particular welded, to the annular disks 3. The actual annular disks 3 can be placed directly on the rotor shaft 1 or via an interposed sleeve or be connected thereto.

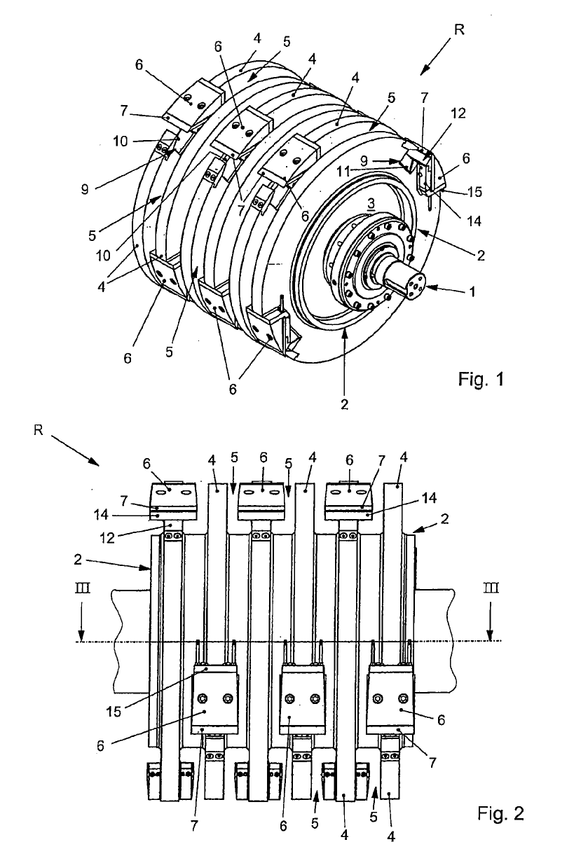

A multiplicity of spaced-apart web elements 4 is placed on the outside of the actual rotor element 2 or connected fixedly, in particular welded fixedly, to the rotor element 2. Here, a peripheral annular groove 5 is formed in each case between the individual web elements 4, as is also clearly apparent from FIGS. 2 and 3.

The respective web elements 4 are preferably situated in a common plane. A plurality of blades 7 are inserted therein in corresponding inserts 6.

In this case, the blades 7 in the insert 6 preferably project on both sides beyond the web element 4 and project into the annular groove 5.

The blades 7 are preferably inserted exchangeably therein via the insert 6.

A particular feature of the present invention is that a recess 8 in which a chip divider 9 is inserted is formed in particular in front of the actual blade 7 or in front of the insert 6 which is inserted into the web element 4.

The chip divider 9 can be inserted fixedly into the recess 8 or releasably as a separate component or be formed from the web element 4 itself. All possibilities are intended to be covered here.

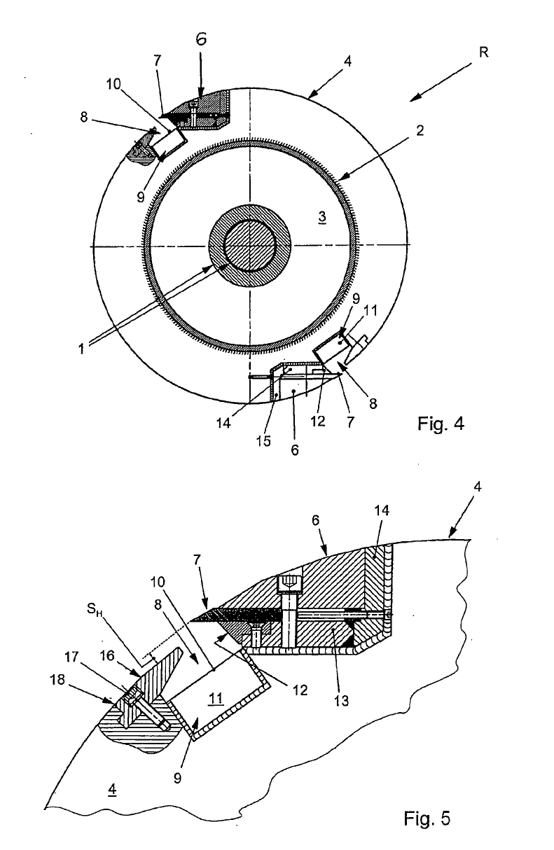

The chip divider 9 has a chip divider blade 10, as is particularly evident from FIGS. 4 and 5, wherein the chip divider blade 10 is oriented approximately in the center of the web element 4 and, as is indicated in FIG. 1, forms respective chip-removing surfaces 11 starting from the chip divider blade 10 and resulting from the formation of an acute angle of the chip divider 9, these surfaces outwardly removing the chip on both sides into the annular groove 5.

In this way, the actual wood chip is discharged in a significantly improved manner, while at the same time the blade 7 itself is preserved. As a result, the service life is increased in combination with a higher throughput.

In addition, it has proved to be advantageous in the present invention for a wear protection element 12 to be connected, preferably below the blade 7, in a releasable manner to the insert 6, said element being produced from a specially fabricated, particularly hardened wear-resistant material. This wear protection element 12 serves for additionally deflecting and removing the chips toward the chip divider 9 and for the improved discharge and removal of the chips into the respective annular grooves 5 adjoining the web element 4. If appropriate, the wear protection element 12 can likewise be provided with an angular design in order to assist in removing the chips on both sides into the respective annular grooves 5.

For the purpose of receiving the insert 6, corresponding baseplates 13 and endplates 14 can be fixedly connected, in particular welded, to the web element 4 in order to ensure that the insert 5 and hence the blade 7 are received exactly.

The wear protection element 12 is preferably inserted exchangeably and releasably in the baseplate 13.

As can be seen from FIG. 1, for example, the baseplate 14 and the endplate 15 also project beyond the web elements 4 on both sides. In this way, a large, stable and exact bearing surface is provided for the actual blade 7 and the insert 6.

Two oppositely arranged blades 7 with inserts 6 are preferably provided on one web element 4.

On the respectively adjacent web element 4, two oppositely arranged blades 7 with two inserts 6 are then likewise again inserted in an integrated manner in the web element 4, but arranged offset with respect to the respectively adjacent web element 4 through 90° for example, as can be seen from FIGS. 1 and 2.

The scope of the present invention is also intended to cover a situation in which, for example, only one or more inserts 6 with blades 7 can be arranged in the web element 4, in which case the blades 7 are then likewise arranged with an offset in the respective adjacent web element 4, so that the respective annular groove 5 in the region of the insert 6 or the blade 7 can still be kept open. This results in an additional improvement in chip discharge.

As is apparent from the exemplary embodiment according to FIG. 5, it has additionally proved to be advantageous in the present invention for a wear element 16 to be inserted, preferably exchangeably or fixedly, into the web element 4 in front of the actual recess 8 or in front of the chip divider 9. Here, the wear element 16 is preferably inserted fixedly or releasably in a shoulder 18 of the web element 4 by means of a fastening element 17 and at least partially projects beyond the recess 8.

The wear element 16 is preferably approximately of a width which corresponds to the width of the web element 4.

The wear element 6 is formed from a particularly hard material, and in its outer contour slightly reduces the radius or the diameter of the web element 4. This ensures that the organic material to be comminuted is fed to the actual blade 7 and, as a result, a gap height S_{H} can be varied and influenced without varying or influencing the blade 7 itself in its position.

It is possible through the variation or through the selection merely of another wear element 16 having a different geometric shape, different radius, different thickness or even length for the gap height S_{H} to be varied or adjusted. It is possible through the variation of the gap height S_{H} to influence very easily and very quickly the production of different wood chips for the process of comminuting the organic material. Adjusting the gap height S_{H} means that a wood chip length can be set exactly.

Furthermore, it is advantageous that, through a correspondingly formed high-grade and hardened material, the wear element 16 serves not only for setting and determining the chip height S_{H}, but also can be exchanged very quickly in this region after being exposed to corresponding wear. This is also intended to come within the scope of the present invention.

1-16. (canceled)

17. A comminuting rotor for producing wood chips, comprising a rotor shaft, a rotor element on the rotor shaft, the rotor element comprises axially spaced-apart web elements at least partially encircling the rotor element, and blades inserted in the web elements.

18. A comminuting rotor for producing wood chips, comprising a rotor shaft, a rotor element on the rotor shaft, the rotor element comprises axially spaced-apart web elements at least partially encircling the rotor element, and blades inserted in the web elements, and in front of the blades at least one of chip dividers and wear protection elements are inserted.

19. A comminuting rotor for producing wood chips, comprising a rotor shaft, a rotor element on the rotor shaft, the rotor element comprises axially spaced-apart web elements at least partially encircling the rotor element, and blades inserted in the web elements, wherein at least one wear element is inserted into a web element in front of the respective blades.

20. The comminuting rotor as claimed in claim 19 wherein a gap height S_{H} of the wear element in front of the blade is adjustable to influence a length of the wood chip.

21. The comminuting rotor as claimed in claim 18 wherein the wear element at least partially overlaps the chip divider and is connected exchangeably to the web element.

22. The comminuting rotor as claimed in at least one of claims 17-19 wherein the blades terminate flush with the rotor element outside diameter and laterally overlap the web element radially on at least one side.

23. The comminuting rotor as claimed in at least one of claims 17-19 wherein the blades are wider than the respective web elements of the rotor element.

24. The comminuting rotor as claimed in at least one of claims 18 and 19 wherein the blade includes an additional wear protection element in the region of an underside.

25. The comminuting rotor as claimed in claim 24 wherein the wear protection element is connected releasably and exchangeably to the web element for receiving and holding the blade with respect to the rotor element and web element.

26. The comminuting rotor as claimed in claim 25 wherein the blade and/or the wear protection element is inserted in the insert or with the insert such that it/they can be released from the web element of the rotor element and exchanged.

27. The comminuting rotor as claimed in at least one of claims 17-19 wherein a recess is formed in front of the blade.

28. The comminuting rotor as claimed in claim 18 wherein the chip divider is inserted into a recess in the web element of the rotor element.

29. The comminuting rotor as claimed in claim 18 wherein the chip divider has a chip divider blade and chip-removing surfaces are formed on both sides of the blade.

30. The comminuting rotor as claimed in at least one of claims 17-19 wherein an annular groove is formed between the respective web elements which are fixedly connected to the rotor element.

31. The comminuting rotor as claimed in claim 29 wherein the chip-removing surfaces are oriented toward an annular groove formed between adjoining web elements.

32. The comminuting rotor as claimed in at least one of claims 17-19 wherein individual, spaced-apart annular disks are on the rotor shaft and serve for the radial spacing and centering of the cylindrical rotor element on which the respective web elements are fixed.
